(19) United States
(12) Patent Application Publication
(10) Pub. No.: US 2024/0026080 A1
(43) Pub. Date: Jan. 25, 2024

(54) METHOD FOR PRODUCING NYLON

(71) Applicant: Aladdin Manufacturing Corporation, Calhoun, GA (US)

(72) Inventor: Anthony Cascio, Calhoun, GA (US)

(21) Appl. No.: 18/356,785

(22) Filed: Jul. 21, 2023

Related U.S. Application Data
(60) Provisional application No. 63/391,199, filed on Jul. 21, 2022.
(60) Provisional application No. 63/423,687, filed on Nov. 8, 2022.

(51) Int. Cl. C08G 69/48; C08G 69/16; C08G 69/42

(52) U.S. Cl. CPC C08G 69/48; C08G 69/16; C08G 69/42

(57) ABSTRACT

The present invention relates to a method for producing nylon, said method comprising the steps of providing a nylon base material being sulfonated in the polymer backbone and/or on polymer amine-end groups, said nylon base material comprising a sulfur content of at least 200 ppm; mixing the nylon base material with an additive, said additive comprising an amine-end group terminating agent and/or a sulfonating agent, and optionally at least one further additive; thereby obtaining a nylon polymer mixture and reacting the nylon polymer mixture thereby obtaining a nylon polymer, said nylon polymer being characterized by a lower amine-end group content than the content of amine-end group of the nylon base material. The present invention further relates to a method for producing nylon base material. In another aspect, the present invention relates to a nylon base material. In another aspect, the present invention relates to a nylon polymer.

### CROSS-REFERENCE TO RELATED APPLICATIONS

This application claims the benefit of priority to U.S. Provisional Application No. 63/391,199, filed on Jul. 21, 2022, and U.S. Provisional Application No. 63/423,687 filed on Nov. 8, 2022, the disclosures of which are expressly incorporated by reference herein in their entirety.

### BACKGROUND

Nylon is commonly used to produce synthetic fibers, which are used for example in clothing, carpets and the like. The structural and mechanical properties of nylon make it very attractive for various commercial and industrial applications. For example, carpets made from nylon are a popular and durable choice for various residential and commercial applications. Such carpets are relatively inexpensive and feature a desirable combination of qualities with respect to durability, aesthetics, safety, warmth/thermal properties and acoustic properties.

However, the chemical nature of nylon, which is a polyamide polymer, makes it particularly prone to reaction with acidic groups. Such acidic groups may be present, for example, in food, beverages such as wine, juices, coffee and the like. The chemical reactivity may be particularly unfavorable with respect to the esthetic appearance of products made of nylon, as such reactivity may result in formation of stains on such products.

To minimize this reactivity of nylon, various chemical modifications of the polyamide polymer are known in the prior art, for example in U.S. Pat. Nos. 5,108,684, 4,579,762 and 3,640,942. The chemical modifications of polyamide polymer are typically directed to blocking negative charges on fibers as to prevent acid dyes from attaching to fibers. Topical treatments are known and sometimes used, but are usually not optimal as such topical application may be prone to water extraction and removal, and wear during the use of the products made of nylon.

Some of the prior art documents, such as U.S. Pat. Nos. 4,579,762 and 3,640,942, disclose the sulfonation of nylon, as an effective chemical modification to reduce the reactivity of the polyamide polymer and yarns obtainable thereof.

The procedure, known in the art from, for example, U.S. Pat. No. 5,889,138, is based on an addition of a metal salt of an aromatic sulfonate such as sodium sulfoisophthalic acid to the reaction mixture, in order to terminate nearly all of the amine-end groups and obtain a highly sulfonated nylon copolymer. The outcoming polymer is characterized by a high sulfur content which is favored in view of stain resistance. However, such high concentrations limit the availability of the polymer end groups to react and build molecular weight, resulting in a low production rate and a reduced economic benefit. To minimize such undesired decrease of the polymerization rate of a sulfonation process, an additional, rate-promoting agent can be added to the mixture. In this case, the reduced rate is preferably modified with the addition of a diamine, such as hexamethylene diamine, which allows the polymer to reach sufficient molecular weight. However, producing the sulfonated nylon polymer of a desired sulfonation level while keeping high production rates and thus efficient polymerization process, remains challenging.

WO 2014/153251 aims to improve the polymerization reaction rate, while providing a stain-resistant, chemically modified nylon. In this document, a multi-stage process for continuous producing nylon polymer is disclosed, wherein the prepolymer reaction mixture is reacted in a prepolymerization zone and the sulfonated prepolymer is transferred into a polymerization zone wherein the polymerization process is finalized. However, this method requires an extensive preparation of the polymerization materials and discloses the addition of the full amount of sulfonating agents in the prepolymerization zone, which increases the cost and lowers the efficiency. On the other hand, such industrial setup leads to cladding and damage to the equipment, especially to a prepolymerization reactor, which requires frequent cleaning and leads to a high maintenance cost.

The prior art methods teach to either compromise on the reaction rate and therefore productivity of the polymerization, or to add lower amount of sulfonating agent to the polymer mixture, which eventually leads to a decreased stain-resistance of the obtained nylon. Further, the prior art methods are found to be inefficient, for example by requiring extensive preparation of the starting material and/or high cost of the equipment maintenance.

### SUMMARY

The present invention, in the first place, aims to provide an alternative or improved method for nylon production.

Furthermore, in accordance with one or more of the preferred embodiments, the present invention provides solutions to one or more problems associated with the manufacturing of nylon.

With this aim, the present invention, in accordance with a first independent aspect, relates to a method for producing nylon, said method comprising the steps:
providing a nylon base material, said nylon base material being sulfonated in the polymer backbone and/or on polymer amine-end groups, and wherein said nylon base material comprises a sulfur content of at least 200 ppm, preferably at least 400 ppm and preferably at most 1500 ppm;
mixing the nylon base material with at least an additive, said additive comprising an amine-end group terminating agent and/or a sulfonating agent, and optionally at least one further additive; thereby obtaining a nylon polymer mixture; and
reacting the nylon polymer mixture thereby obtaining a nylon polymer, said nylon polymer having an amine-end group content lower than the amine-end group content of the nylon base material, preferably at least 20% lower than the amine-end group of the nylon base material.

The present invention is directed to a method for producing nylon. In another aspect, the present invention is directed to a method for producing nylon base material. In another aspect, the present invention pertains to a nylon polymer. In another aspect, the present invention relates to a nylon base material. In another aspect, the present invention relates to a flooring product comprising said nylon polymer, said product preferably being a rug, a carpet or a carpet tile. In another aspect, the present invention relates to a garment comprising the nylon polymer. In another aspect, the invention relates to a yarn comprising said nylon polymer.

The method of the disclosure can be used in the process of producing nylon polymer with stain blocking properties. As is known in the art, the stain blocking properties can be obtained by incorporating sulfur in the polymer backbone, for example via sulfonation, and/or via blocking of the amine-end groups, which blocking of the amine-end groups can be also achieved via sulfonation.

The method of the invention describes that a reaction is performed using an amine-end group termination agent and/or a sulfonation agent on the nylon base material, which nylon base material is already sulfonated in the polymer backbone and/or on polymer amine-end groups. The method allows for obtaining the nylon polymer of desired characteristics, such as sulfonation level and/or amine-end group content, preferably by tailoring the conditions of the reaction of said amine-end group termination agent and/or sulfonation agent and the nylon base material.

The claimed method improves the polymerization process in which the nylon base material used in the claimed method, is produced. The method of the invention allows to use less sulfonating nylon base reactant, i.e. the sulfonating agent in the polymerization process in which the nylon base material sulfonated in the backbone and/or amine-end groups is produced. This lower amount of sulfonating agent used increases the rate of the polymerization reaction in the process in which the nylon base material is produced.

Furthermore, as less sulfonating agent is used in this process, a reactor in which the nylon base material is provided will be less prone to sulfur plating. Consequently, less cleaning of the reactor is required.

It is another benefit that the nylon base material can be made in large volumes in a big reactor, which is an economical way of producing. In the method according to the invention, the nylon base material can be tailored in the smaller volumes to desired nylon polymer, for example, with different contents of amine-end groups. Different amine-end groups are, for example, required for solution dyed nylon fibers, compared to nylon fibers died with acid dyes.

It is another benefit of the invention that the nylon polymer is obtained that has a narrower molecular weight distribution. A narrower molecular weight distribution is beneficial for the fiber spinning process and may reduce variations of fiber properties.

The nylon polymer obtained by the method according to the first aspect, comprises sulfur in the form of sulfonate groups, which sulfonate groups are preferably built in the polymer backbone, i.e., the nylon polymer chain. The sulfonate groups behave as a stain blocking agent in the sense that they do not react and/or they can repel acid dyes from the nylon polymer and the products made thereof because of their acidic chemical character.

Sulfur content in the nylon polymer can be determined by, for example, mass spectrometry, chromatography and/or sulfur chemiluminescence, lead acetate tape and/or the like methods. Throughout this document, wherever the sulfur content is referred to, one or more of the above-mentioned methods may be used to determine said sulfur content.

“Nylon” is, as the term, used to describe any polymer in which the repeating units in the molecular chain are linked together by amide groups. The nylon, as used herein, may refer to any synthetic polyamide, such as, but not limited to: PA 46, PA 6, PA 66, PA 69, PA 610, PA 612, PA 11, PA 12, PA 6T/66, PA 6I/6T, PA 6T/6I/66, PA 6T/6I, PA 6I/6T/66 and PA MXD6 as defined in ISO 16396-1, as well as to copolyamides, compounds of polyamides and other polyamides. In this specification, a preferred example of a synthetic polyamide is nylon.

The term “sulfonated” as used herein, refers to a polymer featuring a sulfonate group having the structure “—SO₃H,”. The term “sulfonate metal salt” to a chemical moiety having the structure “—SO₃M,” wherein M is the cation of the sulfonate salt. The cation of the sulfonate salt can be an alkali metal ion such as, Na⁺, K⁺ and/or Li⁺.

Said sulfonating agent may be preferably chosen from sulfonated dicarboxylic acids and the diesters of such dicarboxylic acids. In a further preferred embodiment, aromatic sulfonated dicarboxylic acids and/or the alkali metal salts thereof can be used, for example 5-sulfoisophthalic acid or 5-sulfoterephthalic acid and/or sodium salts thereof. Said dicarboxylic acids are preferred as they allow the incorporation of the sulfonate groups into the polymer backbone of the nylon polymer.

The sulfonating agent may comprise for example sulfophthalic acid, sulfoterephthalic acid, sulfoisophthalic acid, 4-sulfonaphthalene-2,7-dicarboxylic acid, and esters of each, derivatives of sulfonated styrene, 5-sulfoaryloxycarboxilic acid, or 4-sulfoisiophthalic acid, sulfoalkyloxycarboxilic and/or the like.

In an alternative embodiment, said sulfonating agent may be 1,3 bis-(N-succimido)-sodiumsulfoisophthalamide, 1,3-benzeneficarboxylic acid 5-sulfo-1,3-dihydrazide sodium salt,

The amine-end groups (AEG), i.e. the terminal, primary amine groups located at the ends of the nylon polymer backbone, may also react with the sulfonating agent. When the sulfonating agent reacts with said primary amine groups of the nylon polymer backbone, the reaction of neutralization of amine groups takes place, and the amount of free amine-end groups decreases. The amine-end groups may be neutralized with amine-end group termination agents other than sulfonation agent, thereby also leading to the decrease in the free amine group ends. The decrease in the amount of the free amine-end groups in the nylon polymer further contributes to stain-blocking properties of such nylon polymer.

The nylon polymer obtained by the method of the first aspect has a free amine-end group (AEG) content which is lower, preferably at least 20% lower, even more preferably at least 30% lower, than the amine-end group content of the nylon base material.

In a preferred embodiment, the nylon polymer has a sulfur content higher than the sulfur content of the nylon base material. In said preferred embodiment, an additive comprising at least a sulfonating agent can be added in a nylon polymer mixture and reacted, thereby forming the nylon polymer. In a particularly preferred embodiment, the sulfur content of the nylon polymer is at least 10%, preferably at least 20%, most preferably at least 25% higher than the sulfur content than the nylon base material. The advantage of this embodiment is that the sulfur content is increased in the nylon polymer with respect to the nylon base material, which allows for obtaining nylon polymer of desired stain resistant characteristics.

In a preferred embodiment, said increasing in the sulfur content of the nylon polymer with respect to the nylon base material, is achieved by performing the sulfonation in at least two steps, firstly by sulfonation, i.e. introducing the sulfonate moieties in the nylon base material, and secondly by mixing said sulfur base material with at least an additive comprising a sulfonation agent, thereby obtaining the nylon polymer. Such two-step process can allow a provision of a nylon polymer with an advantageous sulfur content, while minimizing risks of plating the reactor in which the nylon base material is provided.

In a preferred embodiment said nylon base material has viscosity number, lower or equal than the viscosity number of nylon polymer in sulfuric acid, measured according to ISO 307:2019. Said viscosity number (VN) is calculated according to ISO 307:2019 using the formula:

VN=( [symbol] / [symbol] ₀−1)×1/c
wherein [symbol] is the viscosity of the solution of the polymer (nylon base material or nylon polymer) in sulfuric acid in a concentration 0.005 g/ml, in Pals or N/m² s
[symbol] ₀ is the viscosity of sulfuric acid, expressed in the same units as η;
[symbol] / [symbol] ₀ is the relative viscosity measured at 25° C. and using the solution of the polymer in sulfuric acid, in a concentration 0.005 g/ml,
c is the concentration of the polymer in sulfuric acid, which is 0.005 g/ml, as used in ISO 307:2019.

Throughout the description, wherever the viscosity number is referred to, it is expressed in units ml/g and is measured and calculated according to the above-mentioned formula, according to ISO 307:2019.

Said difference between the viscosity number of the nylon base material and the viscosity number of the nylon polymer is preferred because it allows providing the nylon polymer which is less prone to hydrolysis and/or other type of chemical degradation. Moreover, the higher the viscosity number of the nylon polymer, the higher is its molecular weight (Mw), which may allow obtaining stronger fibers thereof.

Preferably, said nylon base material has a viscosity number at least 40 ml/g lower than the viscosity number of the nylon polymer, measured in sulfuric acid at 25° C., following the procedure in detail disclosed in ISO 307:2019. In said preferred embodiment, the nylon base material has the relative viscosity of 0.2 RV (relative viscosity) lower than the relative viscosity of nylon polymer, measured in sulfuric acid at 25° C., using the solutions of a concentration of g/ml of nylon base material, and nylon polymer, respectively, as explained in detail in ISO 307:2019.

During the reaction of the nylon polymer mixture, for example in conditions of a reduced pressure, i.e. the pressure lower than atmospheric pressure, preferably under the pressure of between 0 to 10 000 Pa., at least partial removal of the water from the nylon polymer mixture preferably takes place. Thereby, a solid state polymerization of said nylon polymer mixture may occur, which allows for an increase in the relative viscosity of the formed nylon polymer in comparison to the nylon base material. Such higher viscosity of formed nylon polymer is beneficial as it leads to a better stability, i.e., less hydrolysis of such nylon polymer.

Preferably, the nylon polymer mixture is subjected to a step of removing water and/or removing impurities before or during said step of reacting the nylon polymer mixture. Said removing is beneficial as the presence of water and/or impurities during the reacting of the nylon polymer decreases the speed of polymerization by causing, for example, hydrolyses of the nylon polymer. Moreover, the presence of water and/or impurities may lead to nylon polymer of lower viscosity and/or lower uniformity, which may lead to less effective spinning and lower quality of the fiber obtainable thereof.

Preferably, said water and/or impurities, for example a nylon monomer which has not reacted and thus was not built in the nylon polymer, are removed by means of a reduced pressure, preferably by a device such as a vacuum pump or the like. The removal of water and/or other impurities is desired because water and/or other impurities may lead to the hydrolysis and/or degradation of the nylon polymer.

Preferably the step of reacting the nylon polymer mixture is performed in an apparatus, said apparatus being operated under a reduced pressure, i.e. below atmospheric pressure, preferably under reduced pressure between 0 Pa to 10 000 Pa, and/or a nitrogen atmosphere. Said apparatus is preferably equipped with a mixing means, which means allow for a more efficient reacting of the nylon polymer mixture and keeping the reaction at an allowable rate.

Said nitrogen atmosphere can be substituted by any other non-reactive and/or inert or noble gas atmosphere, such as, for example helium atmosphere. For example, said nitrogen and/or other non-reactive gas atmosphere can be provided in a flow which is fluctuating, and for example can vary from 3 to 170 cubic meter per hour (m³/h), or, for example, 2 cubic feet per meter to 100 cubic feet per meter. Both reduced pressure and a nitrogen atmosphere or inert atmosphere in general, can be used during said reaction of the nylon polymer mixture, as such conditions may allow to achieve a desired molecular weight and/or a desired sulfonation content of the obtained nylon polymer.

In a particularly preferred embodiment, the apparatus wherein the nylon polymer mixture is reacted is or comprises an extruder, preferably a twin screw extruder. Said extruder allows for a good rate of reacting the nylon polymer mixture, thereby obtaining the nylon polymer. More preferably, said extruder may be equipped with vents, i.e., devices suited to extract and/or evaporate the water and/or collect the unreacted nylon monomer and optionally other unreacted additives from the nylon polymer mixture. Such vents may for example be vacuum pumps and the like devices. The vents may reduce the water content and/or impurities, thereby reducing the hydrolysis and allowing for the higher molecular weight of the nylon polymer. The vents can allow for a collecting and reusing of the unreacted material, which allows for a more economic and more green process. Said extruder may also be of other type, such as a multiple-screw extruder, a single screw extruder, a planetary extruder or the like. In case of a twin-screw extruder, any design of such twin screw extruder may be used, for example a conical, or a parallel type of twin screw extruder.

Preferably, said nylon polymer has a viscosity number of at least 240 ml/g and of at most 400 ml/g, more preferably at least 300 ml/g and at most 380 ml/g, most preferably at least 350 ml/g and at most 370 ml/g, measured in sulfuric acid at 25° C., using 0.005 g/ml solution of nylon polymer in sulfuric acid, as defined in ISO 307:2019. In said embodiment, said nylon polymer preferably has a relative viscosity (RV) at least 2.20 and at most 3.00 RV, preferably at least 2.50 and at most 2.90 RV, most preferably at least 2.75 and at most 2.85 RV, measured at 25° C. and with respect to sulfuric acid, as explained in detail in ISO 307:2019. Said viscosity number and/or relative viscosity is particularly desired if a polymer is to be further processed into a yarn, for example into a bulked continuous filament (BCF) yarn. Said viscosity may be controlled in an apparatus during reacting of the nylon polymer mixture, as well as after said reacting of the polymer mixture. For example, the obtained nylon polymer may be subjected to a step of extracting water and/or impurities, for example unreacted nylon monomer, or unreacted additive, or optionally, the nylon polymer may be subjected to a step of drying.

Preferably, said additive used in the mixing step comprises or is a sulfonating agent, preferably a dicarboxylic sulfonic acid or a derivative thereof, even more preferably an aromatic dicarboxylic sulfonic acid or a derivative thereof. Preferably, said sulfonating agent comprises or is a derivative of 5-sulfoisophtalic acid, said derivative preferably being chosen from a group containing an alkali metal salt, an ester, an anhydride or an acyl derivative of 5-sulfoisophtalic acid. Use of said sulfonating agent may allow for obtaining the nylon polymer with a high and/or desired sulfonation content in the polymer backbone and a desired amine-end group blocking.

In a particularly preferred embodiment, the sulfonating agent comprises or is monosodium 5-sulfoisophtalate. Said sulfonating agent is preferred because of its low price and a good solubility during the mixing.

In another preferred embodiment, said sulfonating agent comprises or is monopotassium 5-sulfoisophtalate.

In another preferred embodiment, said sulfonating agent comprises or is monolithium 5-sulfoisophtalate

In a preferred embodiment, a sulfonating agent is added in a quantity of 1.00 wt. % to 1.75 wt. % calculated on the nylon base material. This quantity may be preferred when the nylon polymer with approximately 2000 ppm of sulfur content is desired.

In another preferred embodiment, the sulfonating agent is added in a quantity of 1.80 wt. % to 2.5 wt. % calculated on the nylon base material. This quantity may be preferred when the nylon polymer with approximately 3000 ppm of sulfur content is desired.

In a preferred embodiment, the additive comprises or is an amine-end group terminating agent, said amine-end group terminating agent preferably being an acid substantially free of sulfur. Said amine-end group terminating agent may be chosen from the group consisting of acetic acid, benzoic acid and terephthalic acid or a mixture thereof. The use of acid substantially free of sulfur can have a positive impact on the speed of the process. Furthermore, such choice of an acid allows for using a relatively cheap and abundant additive which does not cause sulfur plating. Moreover, the acids substantially free of sulfur may be as efficient in terminating the free amine groups of the nylon polymer as the sulfonating agents.

In a preferred embodiment, the amine-end group terminating agent may comprise or be a monocarboxylic sulfonic acid or a derivative thereof, for example sodium 3-sulfobenzoate. Such amine-end group terminating agent is found to be particularly effective in maintaining the speed of the process and the kinetics of reacting the nylon polymer mixture in a favorable manner.

In a particularly preferred embodiment, said mixing the nylon base material with at least an additive comprises addition of at least one further additive, preferably said at least one further additive being an anti-oxidant, colorant, wax, copper additive, catalyst or stabilizer. Said at least one further additive may contribute to the chemical stability of the nylon polymer, as well as to the better stain resistance thereof. Furthermore, said additive can be added to allow easier processability of the nylon polymer, for example, to allow easier formation of yarns comprising said nylon polymer.

In a particularly preferred embodiment, the method further comprises the step of recovering and/or collecting unreacted nylon monomer, preferably during or after reacting the nylon polymer mixture. Preferably, the method of the invention comprises a step of collecting the unreacted, i.e. “free” and/or unbound nylon monomer, which may be present in relative high quantity and which is undesirable, since it may lead to the hydrolysis and/or decomposing of the nylon polymer. Moreover, collecting and preferably reducing the unreacted monomer from the system has an additional positive impact on the molecular weight of the nylon polymer, allowing for the nylon polymer with higher molecular weight, thus better uniformity and/or spinning properties, leading to an improved fiber produced thereof. In one preferred embodiment, at least one evaporation means, such as vacuum pump, which may preferably be coupled to a drying device, may be placed downstream the apparatus wherein the nylon polymer is formed.

In a preferred embodiment said method further comprises the step of exposing the nylon polymer to a pressure of 0 Pa to 10 000 Pa and/or to an inert atmosphere, preferably a nitrogen atmosphere, preferably during 1 to 2 min. In a particularly preferred embodiment, said exposing the nylon polymer to a pressure of 0 Pa to 10 000 Pa and/or nitrogen atmosphere happens downstream the apparatus wherein the nylon polymer is formed. Such pressure values may allow for evaporating an excess amount of water, while nitrogen atmosphere may have a positive impact on the stability of the nylon polymer. In a further preferred embodiment, the nylon polymer is exposed to both the pressure of 0 Pa to 10 000 Pa and the nitrogen atmosphere, as using both of these two exposures may allow for obtaining the nylon polymer with a desired viscosity and/or improved chemical stability.

In a preferred embodiment, the method further comprises pelletizing the nylon polymer, thereby obtaining the nylon polymer pellets, said pellets preferably comprising less than 100 ppm of water. Said pellets may allow easier storing and the transport of the nylon polymer, as well as multiple possibilities for further processing steps suitable for multiple applications.

In a particularly preferred embodiment, the method further comprises spinning of the nylon polymer, thereby obtaining the nylon polymer in a form of fiber, said fiber preferably being a bulked continuous filament (BCF). The nylon polymer of the invention was found to be particularly suited for providing the BCF fiber with an improved stain resistance.

Preferably, the nylon polymer obtained by a method of the invention comprises at most milliequivalents (meq) of amine-end groups/kg of said nylon polymer, more preferably at most 10 meq of amine-end groups/kg of said polymer. Such relatively low amount of non-reacted, terminal amine groups makes the nylon polymer less prone to reaction with acidic groups present in the vicinity of such nylon polymer, thus such nylon polymer is more resistant to staining caused by the reaction with acidic food and beverages.

The content of amine-end groups could be determined by, for example, a volumetric titration, a photometric and/or colorimetric measurements, using for example a ninhydrin reaction method, a molecular weight analysis, a chromatography, or the like methods suitable for determination of the terminal amine groups, known in the prior art. Throughout the document, wherever the content of primary amine groups is referred to, the above mentioned methods may be used for the determination thereof.

Preferably, the nylon polymer comprising a sulfonation in the polymer backbone, i.e. the polymer chain, as well as optionally comprising sulfonation on the terminal amine-end groups of the nylon polymer, has a sulfur content of at least 1900 ppm, preferably at least 2000 ppm, most preferably at least 2500 ppm, and at most 4000 ppm, preferably at most 3000 ppm.

Preferably, the nylon polymer comprises at most 2.0 wt. % of unreacted nylon monomer, preferably at most 1.0 wt. % of unreacted nylon monomer, most preferably at most 0.7 wt. % of unreacted nylon monomer. Such low amount of the unreacted nylon monomer has a positive impact on the chemical stability of nylon polymer, and/or lead to a desired molecular weight and/or molecular weight distribution.

In a preferred embodiment, the steps of mixing the nylon base material with at least an additive thereby obtaining a nylon polymer mixture, and reacting the nylon polymer mixture, are performed on the nylon polymer mixture in a liquid state. Preferably, said steps of mixing and reacting are performed on a molten nylon polymer mixture, which steps of mixing and reacting may be performed in an apparatus equipped with a mixing device, or for example in an extruder.

In one embodiment, the nylon base material may be provided, for example, in a liquid i.e. molten state to be mixed with additives thereby obtaining the nylon polymer mixture. In another embodiment, the nylon base material may be, for example, provided pellets, which pellets are preferably molten in the step of mixing the nylon base material with at least an additive.

Preferably, at least 50%, more preferably at least 60%, most preferably at least 75% of the total sulfonation is present in the backbone of the nylon polymer. In this preferred embodiment, the nylon polymer of an improved stain resistance is obtained. The method of the invention allows the provision of a high level of sulfonation in the nylon polymer backbone, i.e. the polymer chain, without compromising on the speed of the production process. Such nylon polymer is sulfonated in the backbone while featuring free, non-sulfonated amine-end groups, which free amine-end groups can react with carboxyl groups in the reaction mixture, thereby allowing the nylon polymer in an efficient way.

Said sulfonation content can be, for example, determined by infra-red (IR) spectroscopy, other spectroscopy tools, such as UV-VIS mass-spectrometry and the like methods. The amount of sulfonation may be also determined by comparison of parameters such as a viscosity and/or a molecular weight (Mw), the amine-end group and carboxyl-end group content and/or a sulfonation level, to corresponding parameters of a nylon polymer of a known structure. In this document, the content of the sulfonation in the nylon polymer backbone expressed as a percent of the total sulfonation content (%) in the nylon polymer, is preferably measured by one or more or the above methods.

Preferably, the nylon polymer mixture may further comprise one or more of the following further additives: a nucleating agent, a linear chain extender, a terminating agent, a crosslinking agent; and hydrophobic additives.

Alternatively, the nylon polymer may be colored using dyebaths of an acidic pH value, preferably a pH value lower than 6.5, more preferably lower than 5.0, most preferably lower than 4.0, to achieve dying of the nylon polymer. In another alternative, a masterbatch could be used to color the nylon polymer.

In a particularly preferred embodiment, the step of providing the nylon base material comprises:
introducing at least i) a sulfonating nylon base reactant; ii) a nylon forming monomer; and iii) water and preferably iv) a diamine into a reactor, thereby obtaining a nylon base reaction mixture;
reacting the nylon base reaction mixture in the reactor to provide the nylon base material, said nylon base material being sulfonated in the polymer backbone and/or on polymer amine-end groups.

Preferably, the sulfonating nylon base reactant gets incorporated at least partially, preferably to a large extent, into the backbone, i.e. polymer chain of the nylon base material, during the polymerization process in the reactor. Such incorporation of the sulfonate-containing moieties in the nylon base material allows stain-resistance to be built into the nylon base material itself. Incorporation of sulfonate-containing moieties into the nylon base material will allow the nylon base material to repel acid dyes. Thus, these groups can behave as stain blocking agents.

Preferably, the reactor is chosen from a group consisting of a continuous process reactor, an autoclave or a line reactor, said line reactor comprising at least two vessels which vessels are under different pressures relative to each other, preferably with a difference of at least 100 Pa, more preferably with a difference of at least 250 Pa. Said line reactor is also known as for example a “vacuum train”. This particularly preferred embodiment allows for more flexibility, as the nylon base material can be provided in reactors suited for either batch-to-batch or continuous production. The step of providing the nylon base material may be conducted in a reactor section.

The nylon base material made in the reactor, can be considered a prepolymer and/or an intermediate nylon material which comprises an optimized and/or desired sulfonation content. Such sulfonation content of nylon base material may allow for easier reacting of nylon polymer mixture, i.e. reaction mixture comprising the nylon base material and at least an additive, said additive being a sulfonation agent and/or amine-end group terminating agent. Said reacting of said nylon polymer mixture may be done in an additional reactor, but it may also be done in any apparatus equipped with a mixing devices and preferably with vents for extraction of water and/or impurities.

As explained previously, the reactor wherein the nylon base material is provided, is less prone to plating due to the lower amount of the sulfonation agent used. The impurities and/or side reaction products may have a detrimental effect of the reactor parts, for example walls, heating and piping parts, and the like. Additionally, because less of the sulfonation happens in the reactor itself, more amine-end groups are available for reacting with nylon monomer carboxylic groups, thereby allowing more efficient reaction in which nylon base material is formed. Furthermore, because of higher speed and less possibility for interaction with the side products in the reactor, the quality of the obtainable nylon base material is higher.

In a particularly preferred embodiment, said reactor is a column reactor, also known as a continuous process reactor, such as for example a VK (Vereinfacht Kontinuerlich) reactor for a continuous polymerization process. This type of the reactor is particularly preferred since it allows for a good kinetics of the reaction in which the nylon base material is formed. Additionally, this type of reactor can yield high volumes of nylon base material of the desired properties, for example, nylon base material comprising at least 50% of the total sulfonation in the polymer backbone.

In a preferred embodiment, the nylon forming monomer comprises or is caprolactam. This embodiment is preferred in case sulfonated and/or stain resistant nylon 6 is desired.

In another preferred embodiment, the nylon forming monomer comprises hexamethylenediamine and adipic acid. This embodiment may be preferred in case a provision of sulfonated and/or stain resistant nylon 6.6 is desired.

In a preferred embodiment, the nylon base reaction mixture further comprises a nylon base material amine-end group terminating agent. Said nylon base material amine-end group termination agent has a positive impact on the stain resistance of the nylon base material.

In a particularly preferred embodiment, said nylon base material amine-end group terminating agent is added into the nylon base reaction mixture in a concentration of 0.05 wt. % to 0.8 wt. %, calculated based on the weight of nylon base reaction mixture.

Preferably, the nylon base material amine-end group terminating agent comprises or is sodium 3-sulfobenzoate. Said compound may be particularly preferred as it may act as a sulfonation agent.

In another preferred embodiment, the nylon base material amine-end group terminating agent comprises or is an acid substantially free of sulfur, said acid preferably comprising or being benzoic acid, acetic acid, terephthalic acid or a mixture thereof. Said acid substantially free of sulfur may be particularly favored as a low-cost additive which efficiently terminates free amine-end groups.

Preferably, the sulfonating nylon base reactant comprises or is a sulfonic acid, preferably a dicarboxylic sulfonic acid, more preferably an aromatic dicarboxylic sulfonic acid. Preferably, said sulfonic acid comprises or is 5-sulfoisophtalic acid or a derivative of 5-sulfoisophtalic acid, said derivative preferably being an alkali metal salt, an ester, an anhydride or an acyl derivative of 5-sulfoisophtalic acid.

In a particularly preferred embodiment, said nylon base reaction mixture comprises a diamine. Said diamine has a favorable effect on the rates of reacting the nylon base reaction mixture. Thus, said diamine allows to obtain the nylon base material more efficiently and/or allows to obtain a nylon polymer with a desired molecular weight.

The term “diamine”, as used herein, refers to a polyamine with exactly two amino groups. Representative diamines include, but are not limited, to the following exemplary groups including ethylenediamine, 1,3-diaminopropane, butane-1,4-diamine, pentane-1,5-diamine, 1,6-diaminohexane, 1,2-diaminopropane, diphenylethylenediamine, diaminocyloxane, o-xylylenediamine, m-xylylenediamine, p-xylylenediamine, o-phenylenediamine, m-phenylenediamine, p-phenylenediamine, dimethyl-4-phenylenediamine, N,N′-di-2-butyl-1,4-phenylenediamine, 4,4′-diaminobiphenyl, 1,8-diaminonaphthalene.

In a further preferred embodiment, the nylon base reaction mixture comprises the sulfonation nylon base reactant, which is a dicarboxylic sulfonic acid, preferably an aromatic dicarboxylic sulfonic acid and a diamine. Said dicarboxylic sulfonic acid and said diamine are provided in a molar ratio ranging from 2:1 to 1:2, preferably in a molar ratio ranging from 1.5:1 to 1:1.5, more preferably in a molar ratio ranging from 1.2:1 to 1:1.2, most preferably in an equimolar ratio, i.e. a molar ratio of 1:1. Such molar ratio allows for a higher reaction rates and more efficient forming of the nylon base material.

In a preferred embodiment, the nylon base reaction mixture further comprises cysteine. Said cysteine may allow for a higher concentration of sulfur in a nylon base material polymer chains, or in other words, cysteine may be built in the backbone of the nylon base material. Cysteine being build up in a polymer backbone may provide a binding spot for sulfur from a sulfonating agent and/or may allow for change on a structure of a polymer backbone. Cysteine may lead to an increase in bulkiness of a yarn produced. Cysteine is also efficient in the control of the free amine-group ends, which is beneficial in order to control the sulfonation and/or modification of the nylon base material.

Preferably, the nylon base reaction mixture comprises at least: 5-sulfoisophthalic acid or a derivative of 5-sulfoisophthalic acid, hexamethylene diamine, epsilon caprolactam, water and cysteine. In a further preferred embodiment, the nylon base reaction mixture comprises 5-sulfoisophthalic acid or a derivative of 5-sulfoisophthalic acid and hexamethylene diamine. Preferably, said 5-sulfoisophthalic acid or the derivative of 5-sulfoisophthalic acid and said hexamethylene diamine are provided in a molar ratio ranging from 2:1 to 1:2, more preferably in a molar ratio ranging from 1.5:1 to 1:1.5, even more preferably in a molar ratio ranging from 1.2:1 to 1:1.2, most preferably in an equimolar ratio, i.e. a molar ratio of 1:1. In said preferred embodiment, an efficient provision a base material for producing sulfonated nylon 6 is allowed.

In a particularly preferred embodiment, the nylon base reaction mixture comprises: monosodium 5-sulfoisophthalate, hexamethylene diamine, epsilon caprolactam, water and cysteine. Preferably, said monosodium 5-sulfoisophthalate and said hexamethylene diamine are provided in a molar ratio ranging from 2:1 to 1:2, more preferably in a molar ratio ranging from 1.5:1 to 1:1.5, even more preferably in a molar ratio ranging from 1.2:1 to 1:1.2, most preferably in an equimolar ratio, i.e. a molar ratio of 1:1. In said preferred embodiment, conditions for a provision of a base material for producing sulfonated nylon 6 are achieved.

In a preferred embodiment, the nylon base material has a sulfur content of at least 400 ppm, preferably at least 500 ppm, and at most 900 ppm, preferably at most 800 ppm. Such sulfur content allows for a desired sulfonation level of the nylon base material, which can still be reacted efficiently with at least an additive to provide the nylon polymer of desired characteristics.

In a particularly preferred embodiment, the nylon base material has a sulfur content of 700 ppm. Such sulfur content allows for efficient reacting of such nylon base material with at least an additive to provide the nylon polymer of desired characteristics.

In a particularly preferred embodiment, the nylon base material has a viscosity number at least 240 ml/g and at most 400 ml/g, measured at 25° C. in sulfuric acid, and using 0.005 g/ml solution of nylon base material in sulfuric acid, as defined in ISO 307:2019. The relative viscosity of said nylon base material is at least 2.2 to at most 3.0 RV, according to ISO 307:2019.

In a particularly preferred embodiment, the nylon base material has preferably at most more preferably at most 45, most preferably at most 40 milliequivalents (meq) amine-end groups/kg of said nylon base material. Such amount of free amine end groups may allow for a desired stain-resistant properties on one hand, and acceptable flexibility for further processing said nylon base material, i.e. allowing for a mass customization of said nylon base material on the other hand.

Preferably, the nylon base material comprises at least 20 ppm, preferably at least 50 ppm and at most 150 ppm, preferably at most 100 ppm of water. Such water quantity is desired to avoid the hydrolysis of the nylon base material and/or loss of viscosity as a result of hydrolyses of the nylon base material.

Preferably, the nylon base material comprises at most 10 wt. %, preferably at most 5 wt. %, preferably at most 2 wt. %, most preferably at most 1 wt. % of an unreacted nylon monomer. The nylon monomer which is unreacted is undesired, as it may lead to the lower molecular weight of the nylon base material.

Preferably, the nylon base material is provided in a liquid state, i.e. in a form of a molten polymer preferably of a desired molecular weight.

In a preferred embodiment, mixing of the nylon base material with at least an additive, thereby obtaining the nylon polymer mixture, is done in an apparatus equipped with a mixing device and preferably vents.

In one embodiment, mixing of the nylon base material with at least an additive, thereby obtaining the nylon polymer mixture and reacting of said nylon polymer mixture is done in a finishing reactor. Said finishing reactor may be capable of creating very high surface area at reduced pressures, preferably pressures below the atmospheric; more preferably pressures between 0 Pa to 10 000 Pa. Said finishing reactor facilitates the volatilization and/or evaporation of water from the nylon polymer mixture. When water is evaporated from the nylon polymer mixture, reacting by means of a polycondensation occurs, thereby increasing the molecular weight of the nylon polymer formed thereby. Thus, by using a finishing reactor operating at a reduced pressure, a nylon polymer of a desired molecular weight can be obtained at relatively high production rates.

In a preferred embodiment, the nylon polymer is subjected to viscosity adjusting, preferably in a vessel with vents. The nylon polymer can be subjected to the viscosity adjusting in a device which has a high surface which allows for the excess water evaporation. Such device can be, for example, an extractor equipped with vents, said vents being any suitable means for evaporating water, such as vacuum pumps and the like.

Preferably, the nylon polymer obtained by the method of the invention has a viscosity number at least 300 ml/g and at most 400 ml/g, measured at 25° C., in sulfuric acid, and using g/ml solution of nylon base material in sulfuric acid, as defined in ISO 307:2019. In this preferred embodiment, said nylon polymer is preferably of a relative viscosity of 2.5 to 3.0 RV in sulfuric acid, according to ISO 307:2019. Such viscosity allows for a provision of the nylon polymer with a high and/or uniform or non-variating molecular weight, which is favorable for spinning and/or further fiber production thereof.

Preferably, the nylon polymer of the invention has at most 20 meq/kg, preferably at most meq/kg of amine-end groups per kg nylon polymer. Such content of amine end groups makes such nylon polymer resistant to staining with acidic staining agents.

In a preferred embodiment, the step of providing the nylon base material further comprises pelletizing the nylon base material, thereby obtaining nylon base material pellets. This may allow a mass customization, i.e. producing the nylon base material in large quantities, which quantities are intended for further processing into the smaller batches of said nylon base material of particular and/or desired characteristics. The pellets may be favored in such mass customization as they allow for a good processability and a good stability of the nylon base material.

According to a second independent aspect, the present invention relates to a method for manufacturing a nylon base material, the method comprising:
introducing at least i) a sulfonation nylon base reactant; ii) a nylon forming monomer; and iii) water and preferably iv) a diamine into a reactor, thereby obtaining a nylon base reaction mixture;
and
reacting the nylon base reaction mixture in the reactor (5) thereby providing the nylon base material,
characterized in that said nylon base material is sulfonated in a polymer backbone and/or on polymer amine-end groups, and wherein said nylon base material comprises a sulfur content of at least 200 ppm, preferably at least 400 ppm and preferably at most 1500 ppm.

Said method allows for a provision of a relatively high volume of nylon base material which is sulfonated and which comprises a sulfur content of at least 200 ppm, preferably at least 400 ppm and preferably at most 1500 ppm at relatively high polymerization rate. This is at least partially due to the lower amount of the sulfonating agent used as well as to less sulfur plating problems. Thus, the process of provision of said nylon base material may be more economic than the known processes in the prior art. Moreover, the nylon base material obtained by a method according to the second aspect is suitable for mass customization, i.e. producing a nylon base material in high volumes, which could be divided in batches, said batches being suitable for further processing according to the particular needs and/or applications. For example, the further processing may be done to achieve a desired sulfonation and/or amine-end group content, by using the method according to the first aspect of the invention.

In a preferred embodiment, the sulfonating nylon base reactant gets incorporated at least partially, preferably to a large extent into the backbone, i.e. polymer chain of the nylon base material, during the polymerization process in the reactor. Such incorporation of the sulfonate-containing moieties in the nylon base material allows stain-resistance to be built into the nylon base material itself. Incorporation of sulfonate-containing moieties into the nylon base material will allow the nylon base material to repel acid dyes. Thus, these groups can behave as stain blocking agents.

Preferably, the reactor is chosen from a group consisting of a continuous process reactor, an autoclave or a line reactor, said line reactor comprising at least two vessels which vessels are under different pressures relative to each other, preferably with a difference of at least 100 Pa, more preferably with a difference of at least 250 Pa. Said line reactor is also known as for example a “vacuum train”. This particularly preferred embodiment allows for more flexibility, as the nylon base material can be provided in reactors suited for either batch-to-batch or continuous production. The step of providing the nylon base material may be conducted in a reactor section.

The reactor wherein the nylon base material is provided, is less prone to plating due to the lower amount of the sulfonation agent used. The impurities and/or side reaction products may have a detrimental effect of the reactor parts, for example walls, heating and piping parts, and the like.

In a particularly preferred embodiment, said reactor is a column reactor, also known as a continuous process reactor, such as for example a VK (Vereinfacht Kontinuerlich) column reactor for a continuous polymerization process. This type of the reactor is particularly preferred since it allows for good kinetics of the reaction in which the nylon base material is formed. Additionally, this type of reactor can yield high volumes of a nylon base material of the desired properties, for example, a nylon base material comprising at least 50% of the total sulfonation in the polymer backbone.

In a preferred embodiment, the nylon forming monomer comprises or is caprolactam.

In another preferred embodiment, the nylon forming monomer comprises hexamethylene diamine and adipic acid.

In a preferred embodiment, the nylon base reaction mixture further comprises a nylon base material amine-end group terminating agent. Said nylon base material amine-end group termination agent has a positive impact on the stain resistance of the nylon base material.

In a particularly preferred embodiment, said nylon base material amine-end group terminating agent is added into the nylon base reaction mixture in a concentration of 0.05 wt. % to 0.8 wt. %, calculated based on the weight of nylon base reaction mixture.

Preferably, the nylon base material amine-end group terminating agent comprises or is sodium 3-sulfobenzoate. Said compound may be particularly preferred as it may act as a sulfonation agent.

In another preferred embodiment, the nylon base material amine-end group terminating agent comprises or is an acid substantially free of sulfur, said acid preferably comprising or being benzoic acid, acetic acid, terephthalic acid or a mixture thereof. Said acid substantially free of sulfur may be particularly favored as a low-cost additive which efficiently terminates free amine-end groups in the nylon base material.

Preferably, the sulfonating nylon base reactant comprises or is a sulfonic acid, preferably a dicarboxylic sulfonic acid, more preferably an aromatic dicarboxylic sulfonic acid. Preferably, said sulfonic acid comprises or is 5-sulfoisophtalic acid or a derivative of 5-sulfoisophtalic acid, said derivative preferably being an alkali metal salt, an ester, an anhydride or an acyl derivative of 5-sulfoisophtalic acid. Said sulfonating nylon base reactant may allow for a provision of the nylon base material with a desired sulfonation content.

In a particularly preferred embodiment, said nylon base reaction mixture comprises a diamine. Said diamine has a favorable effect on the rates of reacting the nylon base reaction mixture. Thus, said diamine allows to obtain the nylon base material more efficiently and/or allows to obtain a nylon polymer with a desired molecular weight.

In a further preferred embodiment, the sulfonation nylon base reactant comprises a dicarboxylic sulfonic acid, preferably an aromatic dicarboxylic sulfonic acid and a diamine, said dicarboxylic sulfonic acid and said diamine being provided in a molar ratio ranging from 2:1 to 1:2, preferably in a molar ratio ranging from 1.5:1 to 1:1.5, more preferably in a molar ratio ranging from 1.2:1 to 1:1.2, most preferably in an equimolar ratio, i.e. a molar ratio of 1:1. Such molar ratio allows for a higher reaction rates and more efficient forming of the nylon base material.

In a preferred embodiment, the nylon base reaction mixture further comprises cysteine. Said cysteine may allow for a higher concentration of a sulfur in a nylon base material polymer chains, or in other words, cysteine may be built in the backbone of the nylon base material. Cysteine is also efficient in the control of the free amine-group ends, which is beneficial in order to control the sulfonation and/or modification of the nylon base material.

Preferably, the nylon base reaction mixture comprises at least: 5-sulfoisophthalic acid or a derivative of 5-sulfoisophthalic acid, hexamethylene diamine, epsilon caprolactam, water and cysteine. In a further preferred embodiment, the nylon base reaction mixture comprises 5-sulfoisophthalic acid or a derivative of 5-sulfoisophthalic acid and hexamethylene diamine. Preferably, said 5-sulfoisophthalic acid or the derivative of 5-sulfoisophthalic acid and said diamine are provided in a molar ratio ranging from 2:1 to 1:2, more preferably in a molar ratio ranging from 1.5:1 to 1:1.5, even more preferably in a molar ratio ranging from 1.2:1 to 1:1.2, most preferably in an equimolar ratio, i.e. a molar ratio of 1:1. In said preferred embodiment, an efficient provision a base material for producing sulfonated nylon 6 is allowed.

In a particularly preferred embodiment, the nylon base reaction mixture comprises: monosodium 5-sulfoisophthalate, hexamethylene diamine, epsilon caprolactam, water and cysteine. Preferably, said monosodium 5-sulfoisophthalate and said hexamethylene diamine are provided in a molar ratio ranging from 2:1 to 1:2, more preferably in a molar ratio ranging from 1.5:1 to 1:1.5, even more preferably in a molar ratio ranging from 1.2:1 to 1:1.2, most preferably in an equimolar ratio, i.e. a molar ratio of 1:1. In said preferred embodiment, conditions for a provision of a base material for producing sulfonated nylon 6.6 are achieved.

In a preferred embodiment, the nylon base material has a sulfur content of at least 400 ppm, preferably at least 500 ppm, and at most 900 ppm, preferably at most 800 ppm. Such sulfur content allows for a desired sulfonation level of the nylon base material, which can still be reacted efficiently with at least an additive to provide the nylon polymer of desired characteristics.

In a particularly preferred embodiment, the nylon base material has a sulfur content of 700 ppm. Such sulfur content allows for efficient reacting of such nylon base material with at least an additive to provide the nylon polymer of desired characteristics. Moreover, said nylon base material is a versatile and valuable intermediate product, which may be further processed to obtain the nylon polymer which may be, for example, sulfonated, colored, and the line.

In a particularly preferred embodiment, the nylon base material has a viscosity number at least 240 ml/g and at most 400 ml/g, measured at 25° C. in sulfuric acid, and using 0.005 g/ml solution of nylon base material in sulfuric acid, as defined in ISO 307:2019. In said particularly preferred embodiment the relative viscosity of said nylon base material is at least 2.2 to at most 3.0 RV, measured at 25° C. with respect to sulfuric acid, as explained in detail in ISO 307:2019.

In a particularly preferred embodiment, the nylon base material has preferably at most 50, more preferably at most 45, most preferably at most 40 milliequivalents (meq) amine-end groups/kg of said nylon base material. Such amount of free amine end groups may allow for a desired stain-resistant properties on one hand, and acceptable flexibility for further processing of said nylon base material, i.e. allowing for a mass customization of said nylon base material on the other hand.

Preferably, the nylon base material comprises at least 20 ppm, preferably at least 50 ppm and at most 150 ppm, preferably at most 100 ppm of water. Such water quantity is desired to avoid the hydrolysis of the nylon base material and/or loss of viscosity as a result of the hydrolyses.

Preferably, the nylon base material comprises at most 10 wt. %, preferably at most 5 wt. %, preferably at most 2 wt. %, most preferably at most 1 wt. % of an unreacted nylon monomer. The nylon monomer which is unreacted is undesired, as it may lead to the lower molecular weight of the nylon base material.

Preferably, the nylon base material is provided in a liquid state, i.e., in a form of a molten polymer preferably of a desired molecular weight.

According to a third independent aspect, the present invention relates to a method for producing nylon base material pellets, the method comprising the steps:
providing nylon base material by means of the method according to the second aspect;
pelletizing the nylon base material, thereby obtaining nylon base material pellets.

Method according to said independent third aspect allows for producing the nylon base material pellets, which pellets may be used as an intermediate product with versatile application. Said nylon base material pellets are particularly suitable for mass customization, i.e. production of the nylon base material in form of pellets in large volumes, with the intention to further process said pellets in batches of desired and/or targetter characteristics of nylon polymer.

The nylon base material and/or nylon base material pellets, may be used as a suitable intermediate for various applications, for example, for production of a nylon base material yarn or a colored nylon base material yarn.

According to a fourth independent aspect, the invention relates to a method for obtaining a nylon base material yarn, the method comprising:
providing the nylon base material by means of the method according the second aspect, or the nylon base material pellets by means of the method according to the third aspect;
extruding the nylon base material or nylon base material pellets thereby obtaining an extrudate; and
spinning the extrudate thereby obtaining a nylon base material yarn, preferably a bulked continuous filament (BCF) type of nylon base material yarn.

Preferably, said extruding is performed using a twin-screw or a multi-screw extruder. Said twin-screw or a multi-screw extruder is preferred as it allows for a desirable rates of production of the extrudate.

According to a fifth independent aspect, the invention relates to a method for obtaining a colored nylon base material yarn, the method comprising
providing the nylon base material by means of the method according the second aspect or nylon base material pellets by means of the method according to a third aspect;
adding of at least one colorant to the nylon base material or the nylon base material pellets; and
extruding the nylon base material or nylon base material pellets and the colorant thereby obtaining a colored extrudate; and
spinning the colored extrudate thereby obtaining a colored nylon base material yarn, preferably a bulked continuous filament (BCF) type of colored nylon base material yarn.

The method according to the fifth aspect may be used for provision of yarns from the nylon base material or the pellets thereof, which nylon base material is being sulfonated in the polymer backbone and/or on amine-end groups, but still can be colored, using the at least one colorant.

Said at least one colorant may be any colored agent which may be used to achieve a desired color of said nylon base material or nylon base material pellets. Preferably, said at least one colorant is a liquid colorant or a pigment.

Preferably, said extruding is performed in a twin-screw or a multi-screw extruder. Said twin-screw or a multi-screw extruder is preferred as it allows for a desirable rates of production of said colored extrudate.

According to a sixth independent aspect, the invention relates to a method for obtaining a sulfonated nylon base material yarn, the method comprising
providing the nylon base material by means of the method according the second aspect, or nylon base material pellets by means of the method according to the third aspect;
adding of at least one sulfonating agent, and optionally at least one additive to the nylon base material or nylon base material pellets; and
extruding said nylon base material or nylon base material pellets with said at least one sulfonating agent and optionally said at least one additive thereby obtaining a sulfonated extrudate;
spinning the sulfonated extrudate, thereby obtaining a sulfonated nylon base material yarn, preferably a bulked continuous filament (BCF) type of sulfonated nylon base material yarn.

Preferably, said extruding being performed in a twin-screw or a multi-screw extruder. Said twin-screw or a multi-screw extruder is preferred as it allows for a desirable rate of production of said sulfonated extrudate.

Preferably, the method further comprises a step of removing water and/or removing impurities, preferably during and/or after said step of extruding said nylon base material or nylon base material pellets with said at least one sulfonating agent and optionally said at least one additive thereby obtaining the sulfonated extrudate. Removing the water and/or may be particularly preferred in order to reduce hydrolyses and/or undesired, side reactions of said sulfonated extrudate.

In a preferred embodiment, said at least one sulfonating agent is a dicarboxylic sulfonic acid, preferably an aromatic dicarboxylic sulfonic acid or a derivative thereof. Said dicarboxylic sulfonic acid may be preferred as a sulfonating agent which may get incorporated in the polymer backbone of the yarn, and/or it can terminate, i.e. neutralize the amine-end groups of the polymer backbone.

In a particularly preferred embodiment, said at least one sulfonating agent is 5-sulfoisophtalic acid or a derivative thereof, said derivative preferably being chosen from group containing an alkali metal salt, an ester, an anhydride or an acyl derivative of said 5-sulfoisophtalic acid. 5-Sulfoisophtalic acid or a derivative thereof may be favored when a yarn comprising nylon polymer with a high sulfonation content is desired, as such yarn may be used in applications where a stain-resistance is desired.

According to a seventh independent aspect, the invention relates to a nylon base material, wherein said nylon base material being sulfonated in a nylon base polymer backbone and optionally on nylon base polymer amine-end groups, wherein at least 50% of total sulfonation content is in the nylon base polymer backbone, characterized in that said material has a sulfur content of at least 200 ppm, preferably at least 400 ppm, preferably at least 500 ppm, and at most 900 ppm, preferably at most 800 ppm.

The nylon base material according to the independent seventh comprises at least 50% of total sulfonation content in its polymer chain, which can lead to an improved stain resistance of such nylon base material. At the same time, such nylon base material has free amine-end groups on ends of the polymer backbone, which groups allow further polymerization and/or reaction with different additives. Thus, a nylon base material according to the seventh aspect has good processability and/or is suitable for various applications as an intermediate product, which can be further processed to obtain a nylon polymer of desired characteristics. Such nylon base material is suitable for a mass customization, i.e. producing a nylon base material in high volumes, which could be divided in batches, said batches being suitable for further processing according to the particular needs.

Preferably, the nylon base material has a sulfur content of about 700 ppm. Such sulfur content may allow for efficient further reacting of such nylon base material to provide the nylon polymer of desired characteristics. Moreover, said nylon base material is a versatile and valuable intermediate product, which may be further processed to obtain the nylon polymer which may be, for example, sulfonated, colored, and the like.

In a particularly preferred embodiment, the nylon base material has a viscosity number at least 240 ml/g and at most 400 ml/g, measured at 25° C. in sulfuric acid, and using 0.005 g/ml solution of nylon base material in sulfuric acid, as defined in ISO 307:2019. In this particularly preferred embodiment the relative viscosity of said nylon base material is at least 2.2 to at most 3.0 RV, measured at 25° C. with respect to sulfuric acid, as explained in detail in ISO 307:2019. Said viscosity number and/or relative viscosity is preferred as it allows the nylon base material of a desired molecular weight, which is favorable for the further processability of said nylon base material.

In even more preferred embodiment, the nylon base material has a viscosity number at least 340 ml/g and at most 360 mug measured at 25° C. in sulfuric acid, and using 0.005 g/ml solution of nylon base material in sulfuric acid, as defined in ISO 307:2019. In this particularly preferred embodiment, the relative viscosity of said nylon base material is at least 2.7 to at most 2.8 RV, measured at 25° C. with respect to sulfuric acid, as explained in detail in ISO 307:2019. Said viscosity number and/relative viscosity are favored because they allow for a provision of the nylon base material of a particularly preferred molecular weight, for further applications, such as, for example yarn provision and the like.

In a particularly preferred embodiment, the nylon base material has preferably at most more preferably at most 45, most preferably at most 40 milliequivalents (meq) amine-end groups/kg of said nylon base material. Such amount of free amine end groups may allow for a desired stain-resistant properties on one hand, and acceptable flexibility for further processing of said nylon base material, i.e. allowing for a mass customization of said nylon base material on the other hand.

Preferably, the nylon base material comprises at least 20 ppm, preferably at least 50 ppm and at most 150 ppm, preferably at most 100 ppm of water. Such water quantity is desired to avoid the hydrolysis of the nylon base material and/or loss of viscosity as a result of the hydrolyses.

Preferably, the nylon base material comprises at most 10 wt. %, preferably at most 5 wt. %, preferably at most 2 wt. %, most preferably at most 1 wt. % of an unreacted nylon monomer. The nylon monomer which is unreacted is undesired, as it may lead to the lower molecular weight of the nylon base material.

Preferably, the nylon base material may be obtainable or obtained by the method according to the second aspect and/or any of the preferred embodiments thereof. Various elements and features corresponding to the nylon base material obtainable by the method according to the second aspect could be incorporated as the preferred features of the nylon base material of the seventh aspect, and are, as such, encompassed by this invention.

In an eighth independent aspect, the present inventing relates to a nylon polymer characterized in that said nylon polymer is sulfonated in a polymer backbone and/or on nylon polymer amine-end groups, characterized in that said polymer has a sulfur content of at least 1500 ppm and preferably of at most 4000 ppm.

The nylon polymer according to said eighth independent aspect has a sulfur content of at least 1500 ppm and at most 4000 ppm. Said sulfur content allows for good processability of said nylon polymer and multiple applications, while preserving the stain blocking characteristics. The sulfur content lower than 1500 ppm does not allow the sufficient stain resistance to acidic stain dyes. The sulfur content of more than 4000 ppm would lead to a nylon polymer which has very little amine-end groups, and as such it cannot be reacted to any additional additives. Moreover, rates of all possible reactions and processes would be significantly reduced by using the nylon polymer having a sulfur content of more than 4000 ppm.

In a preferred embodiment, the nylon polymer has a sulfur content of at least 1800 ppm and of at most 3200 ppm. This range of sulfur content is particularly preferred as it gives an optimal balance between stain resistance and free amine-end groups, which may allow further processing of said polymer and/or using the nylon polymer in various applications.

In another preferred embodiment, the nylon polymer has a sulfur content of at least 2000 ppm, preferably at least 2500 ppm, most preferably at least 3000 ppm.

Preferably, the nylon polymer has a viscosity number at least 300 ml/g and at most 400 ml/g measured in a sulfuric acid, according to ISO 307:2019. In said preferred embodiment, the nylon polymer has relative viscosity of 2.5 to 3.0 RV, measured at 25° C. with respect to sulfuric acid, as explained in detail in ISO 307:2019. Said viscosity number/and or relative viscosity allow for obtaining a nylon polymer of a desired molecular weight, which may be particularly suitable for further spinning.

Preferably, the nylon polymer has a viscosity number 350 ml/g, preferably at least 360 ml/g and at most 380 ml/g, preferably at most 370 ml/g, measured in a sulfuric acid, according to ISO 307:2019. In a further preferred embodiment, the nylon polymer has a relative viscosity of at least 2.75 RV, preferably of at least 2.80 RV, and at most 2.90 RV, preferably at most 2.85 RV, measured at 25° C. with respect to sulfuric acid, and using 0.005 g/ml solution of nylon base material in sulfuric acid, as explained in detail in ISO 307:2019. The nylon polymer of such characteristics is particularly preferred for yarn applications.

Preferably, the nylon polymer features the structure with at least 50% of the total sulfonation content in the polymer backbone, i.e. incorporated in the polymer chain of said nylon polymer. More preferably at least 60% of the total sulfonation content is present in a polymer backbone of said nylon polymer. In a further preferred embodiment, at least 75% of the total sulfonation content is in a polymer backbone of said nylon polymer.

Preferably, the nylon polymer may be obtainable or obtained by the method of the first aspect, and/or obtainable or obtained from the prepolymer according to the seventh aspect of the invention and/or any of the preferred embodiments thereof. Various elements and features corresponding to the nylon polymer by the method according to the first aspect could be incorporated as the preferred features of the nylon polymer of the eighth aspect, and are, as such, encompassed by this invention.

In a ninth independent aspect, the present invention relates to a flooring product, said product comprising the nylon polymer according the eight aspect or the nylon polymer obtained by the method according the first aspect.

Preferably, said flooring product is chosen from a group consisting of a carpet, a rug or a carpet tile.

As used herein, and unless the context clearly indicates otherwise, the term carpet is used to include broadloom carpet, carpet tiles, and even area rugs. To that “broadloom carpet” means a broadloom textile flooring product manufactured for and intended to be used in roll form. “Carpet tile” denotes a modular floor covering, conventionally in 45.72 cm×45.72 cm (18″×18″), 60.96 cm×60.96 cm (24″×24″) or 91.44 cm×91.44 cm (36″×36″) squares, but other sizes and shapes are also within the scope of the present invention.

In a tenth independent aspect, the present invention relates to a woven article comprising the nylon polymer according the eight aspect or the nylon polymer obtainable by the method according the first aspect.

Preferably, the woven article is a furniture cloth or a clothing.

In eleventh aspect, the invention relaters to a yarn comprising the nylon polymer according the eight aspect or the nylon polymer obtainable by the method according the first aspect of the invention.

Preferably, the nylon polymer as disclosed herein is used to spin yarns, in order to produce, for example, flooring products, garments, fabrics, and the like. The term “fiber” as used herein includes fibers of extreme or indefinite length (i.e. filaments) and fibers of short length (i.e., staple fibers). The term “yarn”, as used herein, refers to a continuous strand or bundle of fibers.

In one embodiment, the yarn consists of the nylon polymer according the eight aspect or the nylon polymer obtainable by the method according the first aspect of the invention.

Preferably, the yarn is a bulked continuous filament (BCF) yarn.

As will be appreciated, these yarns will exhibit the stain-resistant properties similar to the nylon polymer of the invention.

In a preferred embodiment, yarns can be made by various conventional methods known to one of skill in the art. As briefly described herein, after extrusion of the nylon polymer into fibers, the fibers are generally formed into yarn, in particular, a bulked continuous filament yarn, or a staple yarn, in accordance with methods known to one of ordinary skill in the art.

It is clear that the yarn according to the eleventh aspect of the invention could be used in manufacturing various textiles, including for example, carpet or carpet tiles, such as, for example flooring product, preferably a carpet, a rug or a carpet tile, according to the ninth aspect, or the garment according to the tenth aspect. For example, in a preferred embodiment, the yarn is drawn and texturized to form a bulked continuous filament (BCF) yarn suitable for tufting into carpets and carpet tiles. In another preferred embodiment, the yarn can be tufted into a pliable primary backing to form a carpet or a carpet tile. In another aspect, the carpet can be tufted carpet, needle-punched carpet, hand woven carpet, broadloom carpet, carpet tile, and even area rugs.

### BRIEF DESCRIPTION OF THE DRAWINGS

With the intention of better showing the characteristics according to the invention, in the following, as an example without limitative character, an embodiment is described, with reference to the accompanying drawing, wherein:

FIG. 1 shows a schematic view of a production line suitable to carry out methods according to the invention;

FIG. 2 in a similar view shows an alternative production line which can be used in the invention;

FIG. 3 shows a schematic view of a reactor suitable to carry out a method according to the second aspect of the invention;

FIG. 4 shows a schematic view of another embodiment of a production line suitable to carry out method according to the first aspect of the invention; and

FIG. 5 shows the schematic diagram of an example of the method according to the first aspect of the invention.

### DETAILED DESCRIPTION

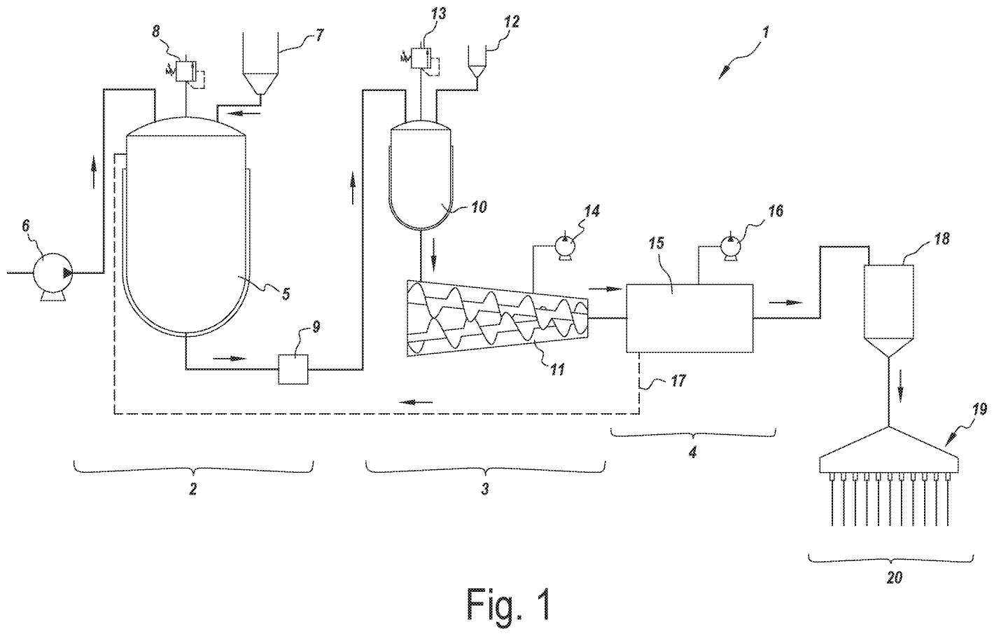

FIG. 1 depicts a manufacturing line 1 suitable for carrying out the method according to the first aspect of the invention. Said manufacturing line 1 is arranged to comprise at least a prepolymerization section 2, suitable for carrying out the step of providing the nylon base material; compounding section 3, wherein the nylon base material is mixed and reacted with at least an additive, said additive comprising an amine-end group terminating agent and/or a sulfonating agent, and optionally at least one further additive, thereby obtaining the nylon polymer and a section for adjusting of the viscosity 4, suitable for adjusting of viscosity of the obtained polymer.

The prepolymerization section 2 is arranged to provide a nylon base reaction mixture into a reactor 5, which is connected to a caprolactam monomer supply unit 6 and a sulfonating nylon base reactant and water supply unit 7. Preferably, said sulfonating nylon base reactant and water supply unit 7 further comprises a diamine and cysteine. The reactor 5 is equipped with a vent valve 8, which valve 8 is configured to release the excess pressure and moist. The nylon base material formed in the reactor 5, can be conveyed to a pelletizer and/or cutter 9, in order to form nylon base material pellets, which nylon base material pellets are then transferred to a compounding and/or polymerization tank 10, which tank 10 is preferably connected to an extruder 11, preferably a twin screw extruder 11. Said compounding and/or polymerization tank is equipped with a feed 12 for at least an additive, said additive comprising an amine-end group terminating agent and/or a sulfonating agent, and optionally at least one further additive, and preferably with a vent valve 13. The at least one additive added to the feed 12 is preferably monosodium 5-sufoisophthalate (SiPa—Na), and preferably at least one further additive being an anti-oxidant. Preferably benzoic acid, catalysts, waxes and the like are also added to said feed 12. Said valve 13 is preferably arranged to release the pressure and/or moisture away from the polymerization tank 10. The twin screw extruder 11 may be a conical twin screw extruder 11 as shown in FIG. 1, but may be a parallel twin screw extruder, or any other type of extruder which may be suitable to be implemented in the method according to the first aspect of the invention. Said extruder 11 is preferably equipped with a vacuum pump 14, which pump allows for controlling the moisture and/or pressure in the extruder, allowing to minimize the unwanted, i.e., side reactions at this stage. The extruder 11 extrudes the nylon polymer to a device for adjusting the viscosity 15. Said device 15 may be any device characterized by surfaces which may be heated and/or cooled under a varying pressure, for example a pressure not exceeding 10000 Pa, which pressure could preferably be decreased to any suitable value. Alternatively, said device for adjusting the viscosity 15 may be maintained under the nitrogen or any inert atmosphere. The device for adjusting the viscosity 15 preferably comprises the elements having large contact surfaces, which surfaces allow for the release of excess water. The device for adjusting the viscosity 15 is preferably connected with a vacuum pump 16, which vacuum pump allows for the removal of the excess water and the unreacted material. Preferably, the device for adjusting the viscosity 15 is connected to the caprolactam collection system 17, which allows for the collecting of the unreacted caprolactam and returning it to the reactor 5.

The nylon polymer which exits the device for adjusting the viscosity 15 is preferably of a viscosity number of 350 ml/g, (i.e., of a relative viscosity of 2.75 RV) with respect to sulfuric acid, according to ISO 307:2019, and preferably having the amine-end group content of less than meq/kg nylon polymer. Said nylon polymer is preferably further directed to a cooling device 18, preferably operated under a nitrogen atmosphere and/or any inert atmosphere and further directed to a spinning machine 19, to provide a yarn 20.

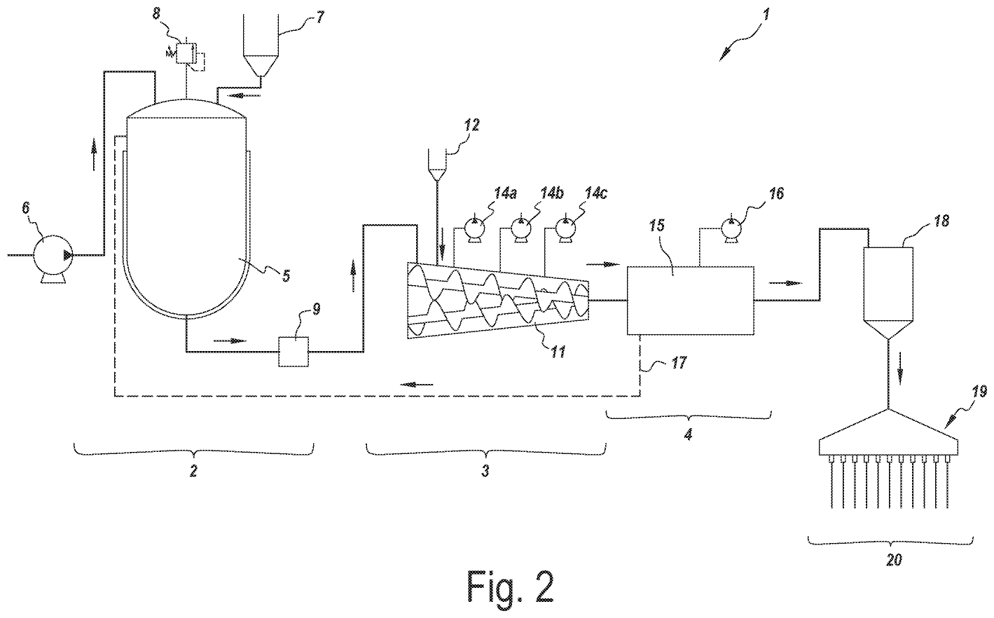

FIG. 2 is a schematical view of an embodiment of the processing equipment suitable for carrying out the method according to the first aspect of the invention. Said embodiment shown in FIG. 2, differs from the embodiment shown in FIG. 1 in the sense that the nylon base material exiting the pelletizer and/or cutter 9, is transferred to an extruder 11, preferably a twin screw extruder 11. Thus, the mixing and reaction of the nylon base material with at least an additive, said additive comprising an amine-end group terminating agent and/or a sulfonating agent, and optionally at least one further additive is performed preferably directly in the extruder 11, which extruder 11 is equipped with a feed 12 for said at least an additive and optionally at least one further additive, and preferably with several vents 14a, 14b, 14c. Said vents 14a, 14b, 14c are preferably arranged to release the pressure and/or moisture away from the extruder 11. Said vents 14a, 14b, 14c may be any suitable device for regulating the pressure and/or releasing the pressure, and preferably are vacuum pumps. The extruder 11 may be a twin screw extruder 11, a conical twin screw extruder 11 as shown in FIG. 2, but may be a parallel twin screw extruder, or any other type of extruder which may be suitable to be implemented in the method according to the first aspect of the invention.

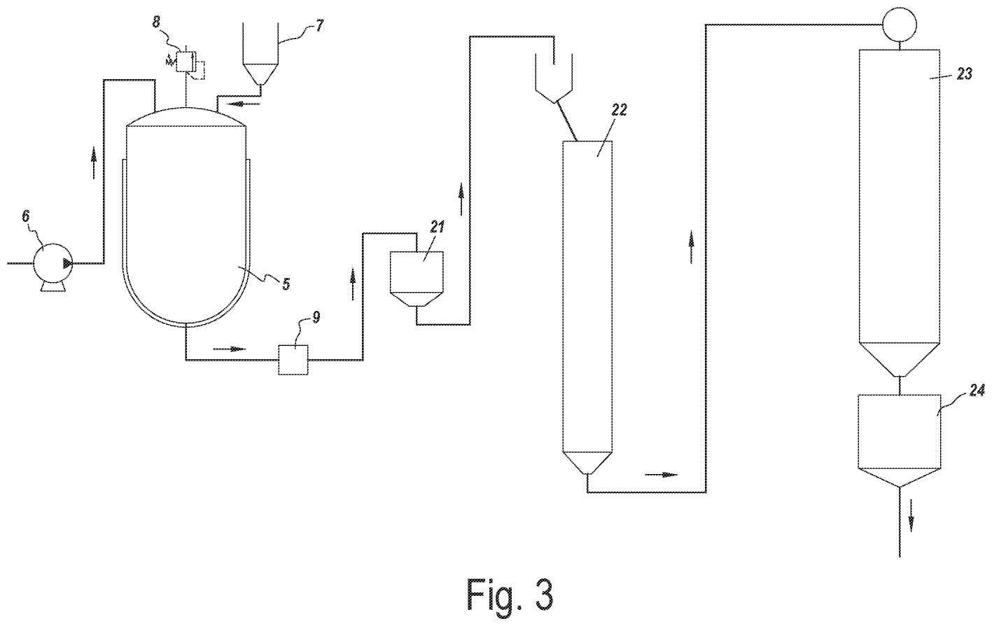

FIG. 3 is a schematical view of an example of the processing equipment for manufacturing the nylon base material in a method according to the second aspect of the invention. It shows a reactor section, equipped with a reactor 5, in which the nylon base reaction mixture is provided. Said reactor 5 is connected to caprolactam supply unit 6 and a sulfonating nylon base reactant and water supply unit 7. The reactor 5 is preferably equipped with a vent valve 8, which valve 8 is configured to release the pressure and moist. The nylon base material formed in the reactor 5, is further optionally conveyed to a pelletizer and/or cutter 9, in order to form the nylon base material pellets. Said pellets are then preferably transferred to a pre-extractor 21 and an extractor 22, which pre-extractor 21 and extractor 22 are preferably characterized by surfaces which may be heated and/or cooled under a varying pressure, for example the pressure not exceeding 10000 Pa, which pressure could preferably be decreased to any suitable value. Alternatively, said pre-extractor 21 and extractor 22 could be operated under atmospheric pressure conditions. Said pre-extractor 21 and/or extractor 22 allow for an extraction of water, unreacted polymer material and/or unreacted additives. Alternatively, said pre-extractor 21 and extractor 22 may be maintained under the nitrogen or any inert atmosphere, if desired. The nylon base material pellets exiting the reactor 5 are preferably conveyed to a dryer 23, in which the temperature preferably does not exceed 120° C., more preferably does not exceed 100° C., most preferably does not exceed 80° C., for a time of less than 30 min, preferably less than 10 min, most preferably less than 5 min. The nylon base material pellets exiting the dryer 23, are preferably conveyed to the cooling device 24, which cooling device is regulated under a temperature not exceeding 70° C., preferably not exceeding 50° C. Said cooling device 24 may be also operated under a nitrogen atmosphere and/or any inert atmosphere known in the art.

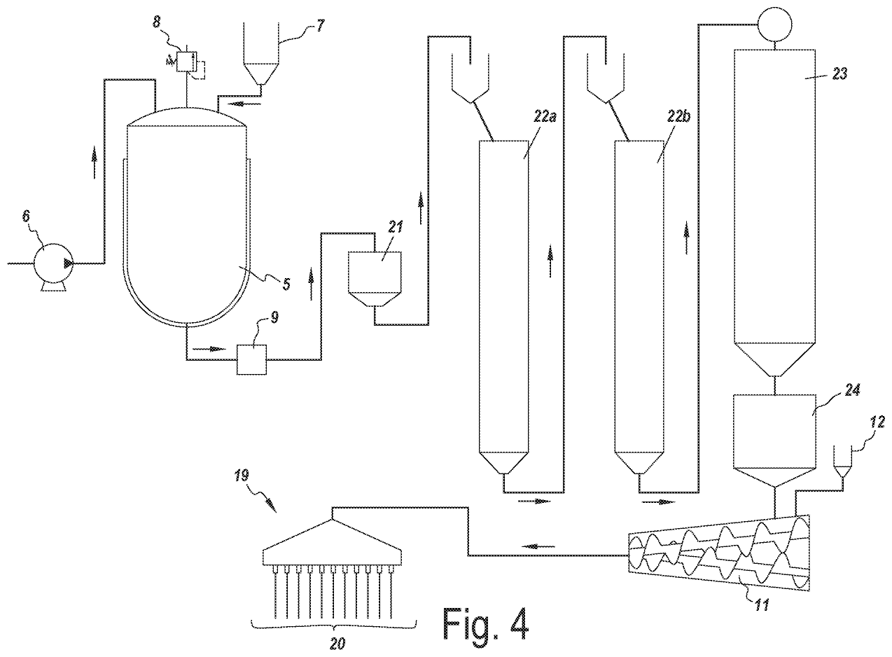

FIG. 4 is a schematical view of an example of the processing equipment suitable to carry out the method according to the first aspect. The processing equipment includes elements described in FIG. 3 and additionally an extruder 11 and a spinning device 19 to produce a yarn comprising the nylon polymer. In FIG. 4, a reactor section, is equipped with a reactor 5, in which the nylon base material mixture is provided. Said reactor 5 is connected to caprolactam supply unit 6 and a sulfonating nylon base reactant and water supply unit 7. The reactor 5 is preferably equipped with a vent valve 8. The nylon base material formed in the reactor 5, is further optionally conveyed to a pelletizer and/or cutter 9, in order to form the nylon base material pellets. Said nylon base material pellets are then preferably transferred to a pre-extractor 21 and an extractor preferably being equipped with two extractor tanks 22a, 22b. As shown in FIG. 4, the extractor is equipped with two extraction tanks 22a, 22b, which are preferably operated at pressures different with respect to each other. The pre-extractor 21 and the extractor tanks 22a, 22b are preferably characterized by surfaces which may be heated and/or cooled under a varying pressure, for example the pressure not exceeding 10000 Pa, which pressure could be decreased to any suitable value. Said pre-extractor 21 and/or extractor tanks 22a, 22b allow for an extraction of water, unreacted polymer material and/or unreacted additives. Alternatively, said pre-extractor 21 and extractor tanks 22a, 22b may be maintained under the nitrogen or any inert atmosphere, if desired. The nylon base material pellets exiting reactor are preferably conveyed to a dryer 23, in which temperature preferably does not exceed 120° C., more preferably does not exceed 100° C., most preferably does not exceed 80° C., for a time of less than 30 min, preferably less than min, most preferably less than 5 min. The nylon base material pellets exiting the dryer 23, are preferably conveyed to the cooling device 24, which cooling device is regulated under a temperature not exceeding 70° C., preferably not exceeding 50° C. The nylon base material pellets are then preferably transferred to an extruder 11, which may be any suitable extruder equipped with a feed 12 for at least one additive. The obtained nylon polymer may be further transferred to a spinning machine 19, and spun into yarns 20.

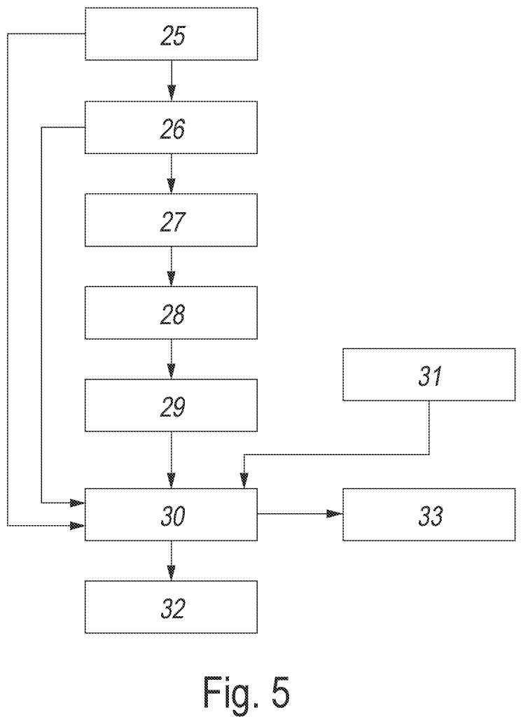

FIG. 5 shows a schematic diagram of an example of the method according to the first aspect. The nylon base material as obtained in the step of reacting the nylon prepolymer reaction mixture in a reactor section 25, is preferably subjected to pelletizing in a pelletizing section 26, and further monomer extraction in an extraction section 27, drying of said pellets in a drying section 28 and a subsequent cooling in a cooling section 29 and transferring to a compounding section 30, supplied with additive supply section 31. Thus, the sections for pelletizing 26, extraction 27, drying 28, cooling 28 and compounding 30 are located downstream with respect to the reactor section 25. Alternatively, the nylon base material in a form of a nylon base material polymer melt may be directly transferred to a compounding section 30, which section 30 is supplied with a supply section 31 for at least one additive. The nylon polymer obtained in the compounding section 30 is preferably further transferred to a spinning section 32, which allows for forming yarns. Alternatively, the nylon polymer may be conveyed to a polymer pelletizing section 33, if that form is desired for further applications.

### EXAMPLES

With the aim of still further illustrating the features of the invention, here below, some examples and the results obtained are listed.

### Example 1. Provision of the Nylon Base Material which could be Provided by the Processing Equipment According to any of the FIGS. 1-4

In order to prepare the nylon base material, the following ingredients are added to a reactor to form a nylon base reaction mixture:
0.42 kg of monosodium 5-sulfoisophthalate (SiPa—Na);
0.18 kg of HMD (hexamethylene diamine);
96.42 kg of caprolactam;
2.981 of water

Preferably, terephthalic acid in a concentration of 0.5 wt % calculated based on the nylon base reaction mixture and cysteine in a concentration of 0.4 wt % calculated based on the nylon base reaction mixture, are added to the reactor. SiPa—Na is preferably used in its hydrolyzed form, to increase dissolving in water, however other forms are also possible. The nylon base reaction mixture is subjected to reacting in the reactor, preferably a VK type of a column reactor for a continuous polymerization, which yielded 99.83% of a nylon prepolymer characterized by a viscosity number of 350 ml/g to 300 ml/g (i.e. the relative viscosity (RV) of 2.75 to 2.5), with respect to sulfuric acid, according to ISO 307:2019, a sulfur content of 700 ppm, and an amine-end group content of 44 meq/kg (milliequivalents of primary amine-end groups per kilogram of nylon base material).

### Example 2. Preparation of the Nylon Polymer Having 2000 ppm Sulfur Content which could be Provided by the Processing Equipment According to any of the FIG. 1, 2 or 4

The nylon base material obtained in the Example 1, was mixed with 1.25 wt. % of monosodium 5-sulfoisophthalate (SiPa—Na), calculated based on the nylon base material, thereby obtaining the nylon polymer mixture. Preferably, additional additives, such as copper additives, waxes and antioxidants are also added into the nylon polymer mixture. Said nylon polymer mixture is reacted in an extruder operated under the reduced pressure not exceeding 8000 Pa. The obtained nylon polymer is characterized by 2000 ppm of sulfur, a viscosity number of 350 ml/g (i.e. a relative viscosity (RV) of 2.75) with respect to sulfuric acid, measured according to ISO 307:2019 and an amine-end group content of 9.8 meq/kg (milliequivalents of primary amine-end groups per kilogram of nylon polymer).

### Example 3. Preparation of the Nylon Polymer Having 3000 ppm Sulfur Content which could be Provided by the Processing Equipment According to any of the FIG. 1, 2 or 4

The nylon base material obtained in the Example 1, was mixed and reacted with 2.1% of monosodium 5-sulfoisophthalate (SiPa—Na), calculated based on the nylon base material, thereby obtaining the nylon polymer mixture. Preferably, the additional additives, such as copper additives, waxes and antioxidants are added to are further added to the nylon polymer mixture. Said nylon polymer mixture is reacted in an extruder operated under the reduced pressure not exceeding 8000 Pa. The obtained nylon polymer had a sulfur content of 3000 ppm, a viscosity number of 360 ml/g (i.e., a relative viscosity (RV) of 2.8) with respect to sulfuric acid, measured according to ISO 307:2019 and an amine-end group content of 9.5 meq/kg (milliequivalents of primary amine-end groups per kilogram of nylon polymer).

### Example 4. Preparation of the Nylon Polymer Having 700 ppm Sulfur Content which could be Provided by the Processing Equipment According to any of the FIG. 1,2 or 4

The nylon base material obtained in the Example 1, was mixed and reacted with 0.2% benzoic acid, calculated based on the nylon base material, thereby obtaining the nylon polymer mixture. Preferably, additional additives are added to the nylon polymer mixture, such as copper additives, waxes and antioxidants are added in a total amount not exceeding 1% of said additional additives calculated based on the nylon polymer mixture. Said nylon polymer mixture is reacted in an extruder operated under the reduced pressure not exceeding 8000 Pa. The obtained nylon polymer had a sulfur content of 700 ppm, a viscosity number of 350 ml/g (i. e. a relative viscosity (RV) of 2.75), with respect to sulfuric acid, measured according to ISO 307:2019 and an amine-end group content of 9.4 meq/kg (milliequivalents of primary amine-end groups per kilogram of nylon polymer).

### Example 5. Post-Reactor, Viscosity Adjusting of the Nylon Polymer which could be Done by the Processing Equipment According to any of the FIG. 1 or 2

The nylon polymers obtained in Examples 2 or 3 are subjected to adjusting the viscosity, in a device featuring large surfaces which allow to evaporate the excess water and/or impurities, and to provide a nylon polymer of viscosity numbers of 364 ml/g and 376 ml/g (i.e. relative viscosities (RV) in sulfuric acid of 2.82 and 2.88) for the nylon polymers obtained in examples 2 and 3, respectively (measured according to ISO 307:2019). The content of amine-end group content of both samples was less than 10 meq/kg (milliequivalents of primary amine-end groups per kilogram of nylon polymer).

The present invention is not limited to the preferred embodiments described above, but such methods and the products obtained thereby may be realized according to several variants without leaving the scope of the invention.

1.-109. (canceled)

110. A method for producing nylon, comprising:
provide a nylon base material, wherein the nylon base material is sulfonated in the polymer backbone, and wherein the nylon base material comprises a sulfur content of between 200 ppm and 1500 ppm;
mixing the nylon base material with a first additive to obtain a nylon polymer mixture, wherein the first additive comprises an amine-end group terminating agent and a sulfonating agent; and
reacting the nylon polymer mixture thereby obtaining a nylon polymer, wherein the nylon polymer has an amine-end group content that is at least 20% lower than the amine-end group content of the nylon base material.

111. The method according to claim 110, wherein the nylon polymer has a sulfur content that is at least 10% greater than the sulfur content of the nylon base material.

112. The method according to claim 111, wherein the nylon base material has a viscosity number at least 40 ml/g lower than the viscosity number of the nylon polymer, measured in sulfuric acid, according to ISO 307:2019.

113. The method according to claim 112, wherein the nylon polymer has a viscosity number between 240 ml/g and 400 ml/g, measured in sulfuric acid, according to ISO 307:2019.

114. The method according to claim 112, wherein reacting the nylon polymer mixture is performed under reduced pressure of between 0 Pa to 10,000 Pa.

115. The method according to claim 112, wherein reacting the nylon polymer mixture is reacted under an inert atmosphere.

116. The method according to claim 114, wherein the sulfonating agent in the first additive comprises dicarboxylic sulfonic acid.

117. The method according to claim 116, wherein the sulfonating agent comprises 5-sulfoisophtalic acid or a derivative of 5-sulfoisophtalic acid, wherein the derivative is selected from a group consisting of an alkali metal salt, an ester, an anhydride, and an acyl derivative of 5-sulfoisophtalic acid.

118. The method according to claim 117, wherein the sulfonating agent is added in a quantity of 1.80 wt. % to 2.5 wt. % of the nylon base material.

119. The method according to claim 118, wherein the first additive comprises an acid substantially free of sulfur, chosen from the group consisting of acetic acid, benzoic acid, terephthalic acid, and mixtures thereof.

120. The method according to claim 119, wherein the first additive comprises sodium 3-sulfobenzoate.

121. The method according claim 119, wherein mixing the nylon base material with the first additive comprises the addition of a second additive, wherein the second additive is chosen from the group consisting of an anti-oxidant, a colorant, a wax, a copper additive, a catalyst, and a stabilizer.

122. The method according to claim 121, further comprising:
exposing the nylon polymer to a pressure of 0 Pa to 10,000 Pa for a period of between 1 and 2 minutes; and
pelletizing the nylon polymer, wherein the nylon polymer pellets comprise less than 100 ppm of water.

123. A method for manufacturing a nylon base material, comprising:
introducing a feedstock into a continuous process reactor, wherein the feedstock comprises a sulfonated nylon base reactant, a nylon forming monomer comprising caprolactam, water, and a diamine; and
reacting the feedstock in the reactor thereby providing the nylon base material;
wherein the nylon base material is sulfonated in a polymer backbone and on polymer amine-end groups and wherein said nylon base material comprises a sulfur content of between 200 ppm and 1500 ppm.

124. The method according to claim 123, wherein the feedstock further comprises a nylon base material amine-end group terminating agent added in a concentration of 0.05 wt. % to 0.8 wt. %, of the feedstock.

125. The method according to claim 124, wherein the nylon base material amine-end group terminating agent comprises sodium 3-sulfobenzoate.

126. The method according to claim 125, wherein the nylon base material amine-end group terminating agent comprises an acid substantially free of sulfur and is selected from the group consisting of benzoic acid, acetic acid, terephthalic acid, or a mixture thereof.

127. The method according to claim 126, wherein the sulfonating agent comprises 5-sulfoisophtalic acid or a derivative of 5-sulfoisophtalic acid, wherein the derivative is selected from a group consisting of an alkali metal salt, an ester, an anhydride, and an acyl derivative of 5-sulfoisophtalic acid.

128. The method according to claim 127, wherein the sulfonating nylon base reactant comprises a dicarboxylic sulfonic acid and a diamine, wherein the dicarboxylic sulfonic acid and diamine are present in a molar ratio of 1.5:1 to 1:1.5.

129. A sulfonated nylon polymer, comprising:
at least 75% of the total sulfonation content present in the backbone of the nylon polymer;
wherein the nylon polymer has a sulfur content of between 1,800 ppm and 3,200 ppm; and
wherein the nylon polymer has a viscosity number of between 300 ml/g and 400 ml/g when measured in sulfuric acid, according to ISO 307:2019.
